(19) United States
(12) Patent Application Publication
(10) Pub. No.: US 2008/0314360 A1
(43) Pub. Date: Dec. 25, 2008

(54) Premix Combustion Methods, Devices and Engines Using the Same

(75) Inventor: Deyang HOU, Sugar Land, TX (US)

Correspondence Address: QUANTLOGIC CORPORATION, 5111 AVONDALE DRIVE, SUGARLAND, TX, 77479, US

(73) Assignee: Deyang HOU, SUGAR LAND, TX (US)

(21) Appl. No.: 12/143,759

(22) Filed: Jun. 21, 2008

Related U.S. Application Data
(60) Provisional application No. 60/945,583, filed on Jun. 21, 2007.

(51) Int. Cl. F02M 69/04

(52) U.S. Cl. 123/305; 123/445

(57) ABSTRACT

This invention discloses a combustion method, which is for internal combustion engine, which utilizes a variable spray fuel injection wherein it has (i) a variable spray angle with smaller angles for earlier fuel injection and larger angles for later fuel injection, and (ii) variable spray patterns varying from hollow conical shapes for earlier injection to multi-jet shapes for later injection, wherein it has adaptive means to distribute fuel into combustion chamber space based on background pressure and injection timing. A combustion method, which utilizes a combustion chamber which has plural number of annular inner spaces resembling the space inside an automotive tire, which provides means to control propagation paths of combustion reaction radicals and control pressure rise rate, which also provides means to promote stratification of premixed charges. An internal combustion engine utilizing the said combustion methods is also disclosed.

### CROSS-REFERENCE TO RELATED APPLICATION

This application is based on and claims priority to U.S. Provisional Application No. 60945583, filed on Jun. 21, 2007, and the disclosures of each are incorporated herein by reference.

### BACKGROUND OF THE INVENTION

1. Field of the Invention

The present invention relates to combustion methods, devices, and an internal combustion engine using the same, either compression ignition or spark ignition internal combustion engines.

2. Description of the Related Art

While the engine industries have put great efforts for Homogenous Charge Compression Ignition (HCCI) and Premixed Charge Compression Ignition (PCCI) PCCI combustion, the conventional multi-hole fuel injector limits the operation ranges of HCCI and PCCI. The major reasons are due to the fixed injection angle and dense jet nature of conventional sprays. Since currently HCCI or PCCI can only operate in low to medium loads in practical applications, conventional fixed-area nozzle designs have to be compromised for low and high loads. A large spray angle for high loads will bring severe wall (cylinder liner) wetting issues for early injections dictated by HCCI/PCCI mixture formation requirements. A fixed narrow spray angle optimized for premixing will generate more soot formation for high loads. Thus, a variable spray angle and penetration are much better positioned to solve this contradiction between requirements for different injection timings and operation loads. The innovative design of said combustion method and devices has solved this wall-wetting issue through providing a variable spray angle, which is smaller for early injection and becomes larger for late injection, and a variable spray pattern, which is soft hollow conical mist-like spray for early injection with less penetration strength, and becomes multi-jet for late injection with higher penetration strength. Such a variable spray fuel injector was documented in U.S. patent application Ser. No. 10/597,000.

Mixture formation is most critical for PCCI combustion. The essential feature of PCCI is ‘premixed charge’, thus the in-cylinder equivalence ratio distribution is the most critical factor deciding engine emissions and performance. Current practices indicated that only low to moderate loads are practical to deploy HCCI or PCCI due to difficulty in controlling combustion starting point and pressure rise rate. Thus, an effective method to control the combustion reaction rate is important to extend the HCCI or PCCI operation maps.

### SUMMARY OF THE INVENTION

The innovative design of said combustion method and devices has solved early injection wall-wetting issues through providing a variable spray angle, which is smaller for early injection and becomes larger for late injection, and a variable spray pattern, which is soft hollow conical mist-like spray for early injection with less penetration strength, and becomes multi-jet for late injection with higher penetration strength.

The said combustion method here proposed uses a novel combustion chamber design, which divides the combustion reaction space into a plural number of smaller spaces, which has more constrains for reaction radical paths and pressure rise rate before top dead center (TDC). After TDC, the constrained reaction zone can join together, so faster combustion is enabled with a premixed charge to both improve combustion efficiency and reduce emissions.

A premixed charge of fuel and air is desirable for reducing emissions. However, for high engine loads, if all fuel and air is premixed before TDC, in the event of out of controlled combustion before TDC, the sudden release of all the heat energy could damage the engine. Thus, at high engine loads, only partially premix fuel and air before TDC is desirable. At the same time, in order to reduce emissions, an on-going ‘premixing’ process is desired. Thus, a novel method for introducing fuel into the combustion chamber space is desired to distribute certain amount of fuel in desirable locations and prepare the fuel as premixed charge to join faster combustion reaction only after TDC. This innovative method is realized by distributing fuel on the chamber surface uniformly in the format of very small discrete fuel droplets (micro-dew format) approximately in the middle stage of compression stroke. Since fuel distributed in micro-dew format needs longer time to evaporate, majority of the fuel will join faster reaction after TDC. But since the fuel in micro-dew format is formed by uniform distribution of micro droplets, after mixture ignition in combustion chamber space, the micro-dew fuel still can quickly evaporated and become vapor to join faster reaction, thus it reduces conventional diffusion combustion. This innovative discrete micro-dew distribution is unlike pooled fuel film on surface, which may produce pool fire and soot formations and should be avoided. This method solves the contradiction of making fuel premixed and controlling high pressure rise rate. This method of distributing fuel turns the ‘premixed’ combustion into ‘premixed’ plus ‘premixing’ combustion. In another word, it turns into a desirable premixed combustion into a pre-conducted and on-going mixture forming process without the limitation of excessive pressure rise concerns, at the same time, eliminated or substantially reduced diffusion combustion, thus reduce soot and NO sub(x) emissions.

By introducing fuel both with early injection and late injection with adaptive means in the same power cycle, we can produce a adaptive mixed-mode combustion, or adaptive PCCI combustion. In the adaptive PCCI, early PCCI is used to generate in-cylinder radicals to accelerate diffusion combustion and reduce NO sub (x), while accelerated diffusion combustion is used to consume CO and HC produced by PCCI and stabilize combustion. Thus, adaptive PCCI gains significantly enhanced engine efficiency and clean in-cylinder combustion simultaneously.

### BRIEF DESCRIPTION OF THE DRAWINGS

FIG. 1 is a side view of said hollow conical spray (13) pattern; ‘a’ is half conical spray angle;

FIG. 2 is a side view of multi-jet spray (14) pattern;

FIG. 3 is a top view of a mixed-mode multi-jet and hollow conical spray pattern; 11—multi-jet spray, 12—hollow conical spray;

FIG. 4 is an illustration of the nature of a conventional combustion chamber; A, B—points in chamber space;

FIG. 5 is an illustration of an exemplary combustion chamber with a single annular space, which constrains the chemical radical propagation paths; A, B—points in chamber space;

FIG. 6 is an illustration of an exemplary combustion chamber with two annular spaces, which constrains the chemical radical propagation paths; A, B—points in chamber space;

FIG. 7 is an illustration of an exemplary matching of hollow conical spray with combustion chamber to form micro-dew droplet distribution; 31—fuel injector with variable orifice; 32—hollow conical spray; 33—micro fuel droplets; 34—piston top; 35—micro-dew droplets distributed on combustion chamber surfaces; a—half spray angle

FIG. 8 is an illustration of the spray pattern variations along with injection timings through controlling the nozzle needle lift; spray patterns can be varied from hollow conical spray to mixed-mode spray, and multi-jet spray; 41—hollow conical spray with small spray angle 2a; 42—hollow conical spray with larger spray angle 2b; 43—multi-jet spray with larger spray angle 2c;

FIG. 9 is an exemplary internal combustion engine embodiment based on said combustion methods with early injection shown; 51—fuel injector with a variable orifice, 52—hollow conical spray, 53—combustion chamber surface, 54—piston, 55—cylinder, 56—cylinder head;

FIG. 10 is an exemplary internal combustion engine embodiment based on said combustion methods with late injection shown; 57—multi-jet spray matched with combustion chamber;

### DESCRIPTION OF THE PREFERRED EMBODIMENTS

A method of combustion, comprising steps of: (i) determining fuel injection timings by engine speed, fuel injection quantity, (ii) utilizing a fuel injector composing a variable injection orifice, (iii) varying injection spray angles based upon injection timing, wherein spray angles increase with late injection timing and decrease with early injection timing relative to engine top dead center, (iv) varying spray patterns wherein spray patterns tend toward hollow conical shapes with determined early injection timings, and tend toward a multi-jet shape with determined late injection timings, (v) wherein distributing fuel into combustion chamber space and surface with adaptive means based on injection quantity and injection timings, thus enable a mixed-mode premixed and conventional combustion.

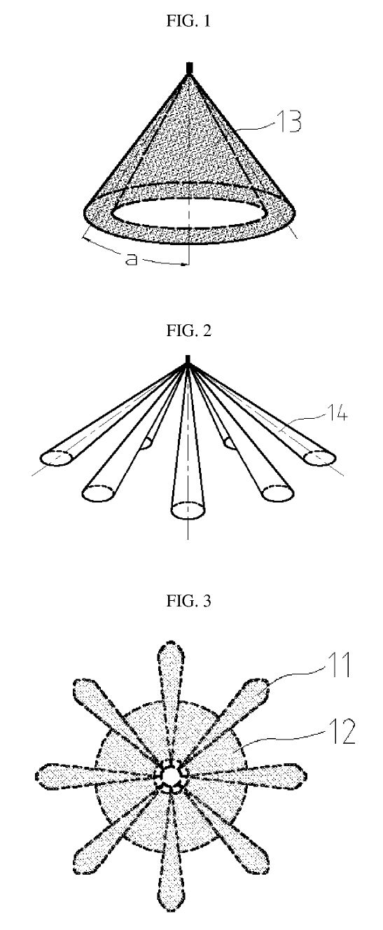

As shown in FIG. 8, the spray pattern can vary along with injection timings through controlling the nozzle needle lift; spray patterns can be varied from hollow conical spray with small angle, to multi-jet spray with larger angle, as shown in FIG. 1 & FIG. 2;

A method of combustion according to above paragraphs, further utilizing a combustion chamber composing plural number of annular inner spaces, which provide adaptive means to distribute mixture charges and to control propagation paths of combustion reaction radicals and control pressure rise rate, which also provide means to promote stratification of premixed charges;

FIG. 5 is an illustration of an exemplary combustion chamber with single annular space, which constrains the chemical radical propagation path. Point A & B in chamber space can not ‘see’ each other directly, the reaction information in point A is restrained to propagate to point B directly;

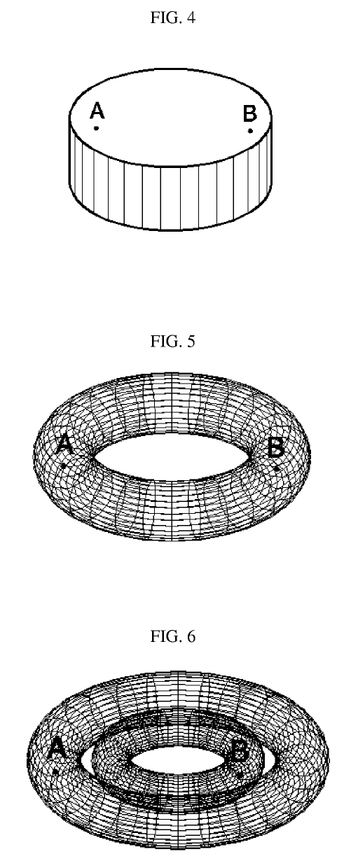

FIG. 6 is an illustration of an exemplary combustion chamber with two annular spaces, which constrains the chemical radical propagation path. Point A & B in chamber space can not see each other directly, the reaction information in point A is restrained to propagate to point B. Thus, the reaction radical paths are controlled, the pressure rise rate could be controlled for premixed charges. This is unlike the point A&B in conventional combustion chamber as illustrate din FIG. 4, in which case A can directly see point B, thus the reaction information in point A, such as high temperature and radiation energy, can be quickly propagated to point B, thus it's difficult to control the pressure rise rate with a premixed mixture charge in such a combustion chamber space.

A method of combustion according to above paragraphs, which is for internal combustion engines, composing steps of partially distributing fuel in discrete micro-dew shape droplets, with majority droplets having a diameter preferably under 20 micron meter, on the surface of the combustion chamber for fast evaporation after top dead center, wherein the fuel injection for micro-dew formation occurs approximately between 120˜40 degree before engine top dead enter;

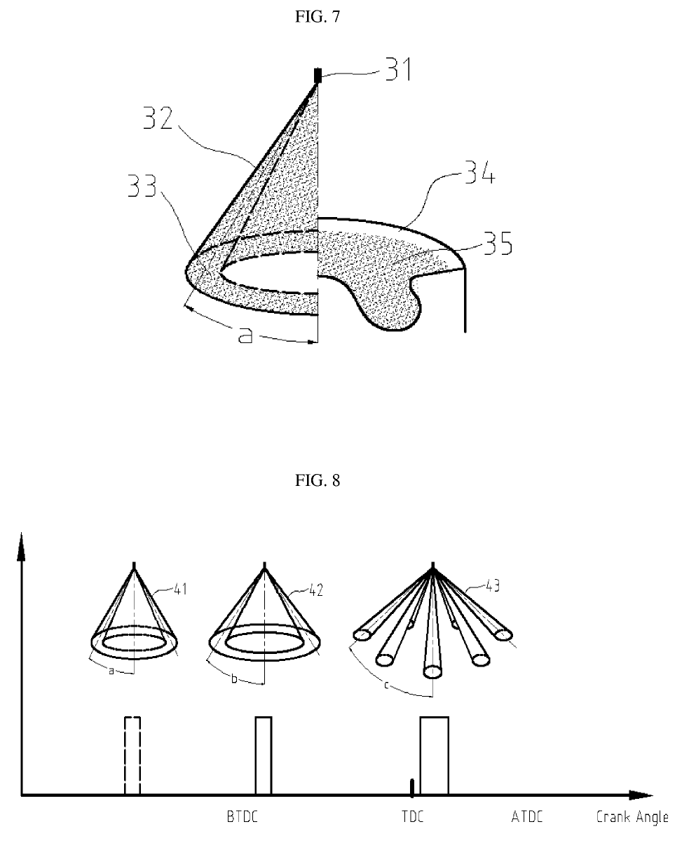

FIG. 7 is an illustration of an exemplary matching of hollow conical spray with combustion chamber to form micro-dew droplet distribution; such micro-dew fuel will evaporate and join fast chemical reaction after top dead center. Thus this method of distributing fuel reduces diffusion combustion, thus reduces soot and NO sub(x) emissions.

A method of combustion according to above paragraphs, comprising steps of defining spray patterns and spray angles through controlling the magnitude of fuel injector needle lift, wherein it has means for varying sprays from pure hollow conical shapes continuously to mixed-mode spray shapes and multi-jet shapes, and varying the spay angle from smaller angles to larger angles;

A combustion method according to above paragraphs, comprising steps of defining a smaller variable spray angle, preferably between 50˜120 for early injection, and a larger variable spray angle, preferably between 120˜150 degree, for late injection closing to engine top dead center;

A combustion method according to above paragraphs, comprising steps of defining a single injection and a plural number of earlier injections with injection timings approximately between 120˜30 degree before top dead center with hollow conical spray shapes, and a main injection with starting injection timing preferably between −10˜20 degree around top dead center with multi-jet sprays, and an optional post injection with injection timings approximately between 40˜70 degree after top dead center with hollow conical spray shapes;

An combustion method according to above paragraphs, further comprising steps of utilizing a plural number of pressure levels for fuel injection, with lower pressure level less than 1000 bar, preferably in the range of 300˜1000 bar, for early injections within range of 120˜30 degree before top dead center; and high injection pressure level above 1100 bar, preferably in the range of 1500 bar ˜2500 bar, with higher pressure preferred, for late injections starting preferably −10˜20 degree after top dead center, depending on the engine speed and fuel injection quantity;

An internal combustion engine composing at least: a said fuel injector with variable injection orifice as in above paragraphs, a combustion chamber, a piston, a cylinder, and a cylinder head with intake and exhaust valves, with said internal combustion engine using the combustion method or devices as in above paragraphs individually or collectively to have means to distribute fuel in combustion chamber space and on combustion chamber surface, to control pressure rise, to control quantity of fuel for premixed mixture formation for adaptive premix combustion for different engine speeds and loads;

An internal combustion engine according to above paragraph, further has a compression ratio approximately in the range of 10˜16, preferably 14˜16, a low swirl ratio approximately in the rage of 0˜1.5, preferably 0.2˜1.0;

An internal combustion engine according to above paragraphs, further composing a said combustion chamber, wherein the quantity of fuel in micro-dew format distributed on combustion chamber surface increases along with the increase of engine loads, wherein for any loads the fuel distributed on chamber surface is preferably less than 25%, wherein the first injection timing advances along with the increase of fuel quantity injected;

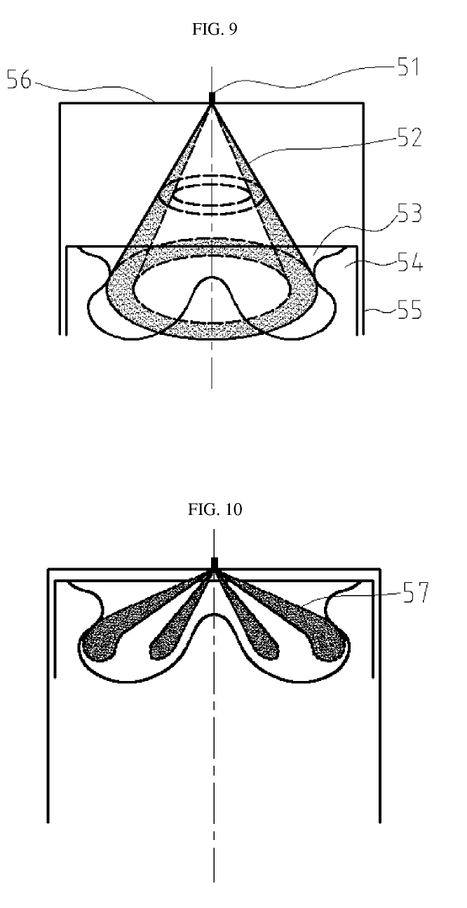

FIG. 9 is an exemplary internal combustion engine embodiment based on said combustion methods with early injection shown; The spray pattern is hollow conical, the spray angle is small, preferably in the range of 50˜100 degree. The early fuel charges will produce a PCCI combustion with extremely low emissions.

FIG. 10 is an exemplary internal combustion engine embodiment based on said combustion methods with late injection shown using a multi-jet spray pattern, the spray angle is preferably in the range of 130˜150 degree. The late charge of the fuel will leverage the radicals produced by early PCCI, and accelerate the diffusion combustion, thus produce high efficiency accelerated diffusion combustion (ADC).

The processes in FIG. 9 and FIG. 10 can be in the same engine power cycle to produce an adaptive mixed-mode premixed and conventional combustion. The new mixed-mode adaptive PCCI combustion can successfully merge the merits of early PCCI and diffusion combustion. The adaptive PCCI minimizes the drawbacks of each combustion mode, produces ultra low emissions and high efficiency with stable combustion simultaneously.

What is claimed is:

1. A method of combustion, comprising steps of: (i) determining fuel injection timings by engine speed, fuel injection quantity, (ii) utilizing a fuel injector composing a variable injection orifice, (iii) varying injection spray angles based upon injection timing, wherein spray angles increase with late injection timing and decrease with early injection timing relative to engine top dead center, (iv) varying spray patterns wherein spray patterns tend toward hollow conical shapes with determined early injection timings, and tend toward a multi-jet shape with determined late injection timings, (v) wherein distributing fuel into combustion chamber space and surface with adaptive means based on injection quantity and injection timings, (vi) enabling a mixed-mode adaptive premix combustion with adaptive early injection and late injection in a same engine power cycle to produce both clean and efficient combustion;

2. A method of combustion according to claim 1, which is for internal combustion engines, utilizing a combustion chamber composing plural number of annular inner spaces, which provide adaptive means to distribute mixture charges and to control propagation paths of combustion reaction radicals and control pressure rise rate, which also provide means to promote stratification of premixed charges;

3. A method of combustion according to claim 1, which is for internal combustion engines, composing steps of partially distributing fuel in discrete micro-dew shape droplets, with majority droplets having a diameter preferably under 20 micron meter, on the surface of the combustion chamber for fast evaporation after top dead center, wherein the fuel injection for micro-dew formation occurs approximately between 120˜40 degree before engine top dead enter;

4. A method of combustion according to claim 1, comprising steps of defining spray patterns and spray angles through controlling the magnitude of fuel injector needle lift, wherein it has means for varying sprays from pure hollow conical shapes continuously to mixed-mode spray shapes and multijet shapes, and varying the spay angle from smaller angles to larger angles;

5. A combustion method according to claim 1, comprising steps of defining a smaller variable spray angle, preferably between 50˜120 for early injection, and a larger variable spray angle, preferably between 120˜150 degree, for late injection closing to engine top dead center;

6. A combustion method according to claim 1, comprising steps of defining a single injection and a plural number of earlier injections with injection timings approximately between 120˜30 degree before top dead center with hollow conical spray shapes, and a main injection with starting injection timing preferably between −10˜20 degree around top dead center with multi-jet sprays, and an optional post injection with injection timings approximately between 40˜70 degree after top dead center with hollow conical spray shapes;

7. An combustion method according to claim 1, further comprising steps of utilizing a plural number of pressure levels for fuel injection, with lower pressure level less than 1000 bar, preferably in the range of 300˜1000 bar, for early injections within range of 120˜30 degree before top dead center; and high injection pressure level above 1000 bar, preferably in the range of 1500 bar˜2500 bar, for late injections starting preferably −10˜20 degree after top dead center, depending on the engine speed and fuel injection quantity;

8. An internal combustion engine composing at least: a said fuel injector with variable injection orifice as in claim 1, a combustion chamber, a piston, a cylinder, and a cylinder head with intake and exhaust valves, with said internal combustion engine using the combustion method or devices as in claim 1, 2, 3, 4, 5, 6, and claim 7 individually or collectively to have means to distribute fuel in combustion chamber space and on combustion chamber surface, to control pressure rise, to control quantity of fuel for premixed mixture formation for adaptive premix combustion for different engine speeds and loads;

9. An internal combustion engine according to claim 8, further has a compression ratio approximately in the range of 10˜16, a swirl ratio approximately in the rage of 0˜1.5;

10. An internal combustion engine according to claim 8, further composing a said combustion chamber as in claim 2, wherein the quantity of fuel in micro-dew format distributed on combustion chamber surface increases along with the increase of engine loads, wherein for any loads the fuel distributed on chamber surface is preferably less than 25%, wherein the first injection timing advances along with the increase of fuel quantity injected;
